(19) United States
(12) Patent Application Publication
(10) Pub. No.: US 2003/0154755 A1
(43) Pub. Date: Aug. 21, 2003

(54) Long-term fertilizer containing nitrogen

(76) Inventors: Klaus Horchler, Limburgerhof (DE); Alexander Wissemeier, Speyer (DE); Reinhard Hahndel, Limburgerhof (DE); Vilmos Czikkely, Mannheim (DE); Wolfgang Weigelt, Dudenhofen (DE); Wolfram Zerulla, St. Martin (DE)

Correspondence Address: COLLARD & ROE, P.C., 1077 Northern Boulevard, Roslyn, NY, 11576-1696, US

(21) Appl. No.: 10/313,441

(22) Filed: Dec. 6, 2002

(30) Foreign Application Priority Data
Dec. 7, 2001 (DE) 101 60 330.4

(51) Int. Cl. C05C 9/00

(52) U.S. Cl. 71/28

(57) ABSTRACT

A long-term fertilizer containing nitrogen, contains a mixture of acetylene diurea and at least one other organic fertilizer containing nitrogen, such as methylene urea, isobutylidene diurea, crotonylidene diurea, oxamide, melamine, substituted triazones, ethylene diurea, triuret or mixtures of them.

### BACKGROUND OF THE INVENTION

1. Field of the Invention

The present invention relates to long-term fertilizers containing nitrogen, methods for their production, and their use.

2. The Prior Art

Fertilizers with a long-term effect have many advantages as compared with conventional mineral or organic fertilizers. They offer a delivery of the nutrients to the plants that is better in keeping with demand, and thereby improve the utilization of the nutrients. This results in a reduction of nutrient losses, thereby reducing the burden on the environment and increasing the efficiency of fertilization. In addition, they make it possible to save work steps and thereby to reduce agriculture business costs.

A long-term effect of fertilizers can be achieved in different ways. One possibility is to surround granulated fertilizers that are easily soluble in water with a coating that is insoluble in water. Nutrient release from such coated fertilizers takes place with a time delay, since the nutrients first have to diffuse through the coating layer, before they can be taken up by the roots. Another possibility is to apply the fertilizers initially in the form of chemical compounds in which they are not available to the plants. Only after a prior release step has taken place, e.g. chemical hydrolysis, enzymatic splitting and/or microbial conversion, are the nutrients present in a form that can be utilized by the plants. Such fertilizers are also referred to as chemical long-term fertilizers.

The idea of chemical long-term fertilizers was already known from the previous century. At that time, Liebig in Germany and Murray in England suggested using nutrients in the form of salts with low solubility for plant nutrition, see also Ullmann's Encyclopedia of Industrial chemistry 1987, Vol. A 10, p. 363 ff. The first patent for a long-term fertilizer with low solubility, on the basis of urea and formaldehyde, was filed in 1924 by IG Farben, today BASF (DRP 431585). Commercial production began in the fifties, in the United States, by DuPont and Nitroform Corp.

Today, a large number of substances that contain nitrogen are being produced and marketed as long-term fertilizers. The three most important ones, by far, are condensation products from urea and formaldehyde, isobutyraldehyde and acetaldehyde, respectively, which are referred to as methylene urea, isobutylidene diurea (IBDU), and crotonylidene diurea (CDU).

During the fertilization year 1995/1996, approximately 317,000 metric tons of such long-term fertilizers were produced, of which 225,000 metric tons were fertilizers containing methylene urea, 82,000 metric tons contained IBDU and CDU, and approximately 10,000 metric tons were fertilizers containing other compounds.

Among the substances produced on a smaller scale, there are both cyclic and acyclic structures. Here, oxamide, acetylene diurea, melamine, substituted triazones, ethylene diurea, and triuret are examples thereof.

These known long-term nitrogen fertilizers differ greatly, in some respects, in their duration of effect, in each instance. While the effect stops relatively rapidly in the case of substances with a shorter period of effect. This is because nitrogen deficiency symptoms frequently occur at the beginning of the culture time in the case of N fertilization solely with compounds with a longer period of effect, since the mineralization from these materials often takes place only after a delay. In addition, not all of these compounds are tolerated by plants without restrictions, and instead result in plant damage, depending on the amount used and the culture being fertilized.

### SUMMARY OF THE INVENTION

It is therefore an object of the present invention to make available fertilizer formulations that are suitable as long-term N fertilizers and are superior to the known substances, preferably in the area of plant tolerance, period of effect, and uniformity of nutrient delivery.

This object is accomplished, according to the present invention, by means of a long-term fertilizer containing nitrogen, containing a mixture of acetylene diurea and at least one other organic fertilizer containing nitrogen.

It was found, according to the present invention, that the effect of acetylene diurea with other organic fertilizers containing nitrogen is derived not only additively from the property profiles of the individual components, but rather that synergistic effects are demonstrated, over and above this, which result in an unexpectedly strong and long-lasting support of plant growth.

The at least one other organic fertilizer containing nitrogen can be selected from among all the known suitable fertilizers of this type. Preferably, the at least one other organic fertilizer containing nitrogen is selected from among methylene urea, isobutylidene diurea, crotonylidene diurea, oxamide, melamine, substituted triazones, ethylene diurea, triuret or mixtures of these compounds.

Isobutylidene diurea is preferred as the at least one other organic fertilizer containing nitrogen.

Such organic fertilizers containing nitrogen are available, for example, from Scotts, Agra, BASF, Vigoro, and Chisso.

For a more detailed description, reference can be made to EP-A-0 578 240 for oxamide, to JP-A-62 288 184 for acetylene diurea, to U.S. Pat. No. 4,778,510 for substituted triazones, to JP-A-49 013 268 for ethylene diurea, and to JP-A-90 35 152 for triuret.

Acetylene diurea and other organic fertilizers containing nitrogen are preferably present in a weight ratio of 1:9 to 9:1, particularly preferably 1:3 to 3:1, particularly 3:2 to 2:3.

The long-term fertilizers according to the present invention can furthermore contain other components as they usually occur in single-nutrient and multi-nutrient fertilizers. For example, they can additionally contain urea or nitrogen, potassium, phosphorus and/or magnesium in the form of inorganic salts, or mixtures of them. Easily soluble nitrogen components are, for example, ammonium nitrate, ammonium sulfate, or urea. Other salts that can be used are, for example, MAP, DAP, potassium sulfate, potassium chloride, magnesium sulfate. These additional components can be the main components of the long-term fertilizer, in addition to the mixtures according to the invention. Furthermore, in addition to the main components, secondary nutrients can also be present. For example, secondary nutrients can be selected from among Ca, S, and B. Trace elements, selected from among Fe, Mn, Cu, Zn, Mo or mixtures of them, can also be present in the form of inorganic salts. Suitable amounts for the secondary nutrients or trace elements are amounts of 0.5 to 5 wt.-%, based upon the total weight of the long-term fertilizer composition. Other possible ingredients are plant protection agents, such as insecticides or fungicides, growth regulators, nitrification inhibitors, or mixtures of them.

Other possible ingredients of the fertilizers according to the invention are described in Ullmann's Encyclopedia of Industrial Chemistry, 5th edition, 1987, Volume A10, pages 363 to 401, DE-A-41 28 828, DE-A-19 05 834, or DE-A-196 31 764.

The long-term fertilizers according to the invention can also be coated, in whole or in part, as described in EP-A-0 877 722 or DE-A-196 31 764.

The long-term fertilizers containing nitrogen, according to the invention, can contain single-nutrient as well as multi-nutrient fertilizers as other usual fertilizer components, for example, which contain nutrients such as nitrogen, potassium, or phosphorus, individually or, if necessary, in combination, in the form of their salts. Examples of these are NP, NK, PK, as well as NPK fertilizers such as lime nitrate of ammonium, ammonia sulfate, ammonia sulfa-nitrate, or urea.

The long-term fertilizers according to the present invention can be obtained according to generally known methods. For example, they can be produced by means of mixing of powders or granules, i.e. granulates of the starting compounds and, if necessary, subsequent granulation. The production of fertilizer granulates is described, for example, in Ullmann's Encyclopedia of Industrial Chemistry, 5th edition, 1987, Volume A10, page 374 to 385.

The long-term fertilizers containing nitrogen, according to the present invention, can be used to fertilize a large number of plants or soils. Preferably, the long-term fertilizers are used to fertilize horticultural or agricultural cultures, particularly lawns or ornamental plants. In this connection, they are usually applied to areas used for agriculture or horticulture according to generally known methods, see also Ullmann's Encyclopedia of Industrial Chemistry, 5th edition, 1987, Volume A10, pages 398 to 401. Because of their high level of plant tolerance, the long-term fertilizers according to the present invention are suitable not only for fertilizing methods in which the fertilizer is applied to the agricultural area more or less uniformly, but also for targeted deposition in the vicinity of the plant root.

The long-term fertilizers according to the invention can fundamentally be used in all sectors of plant cultivation, such as agriculture and horticulture, for example in fruit and vegetable cultivation.

Examples of suitable cultures are ornamental plants, lawns, as well as cultures for consumption, such as apples, pears, strawberries, tomatoes, peppers, and others.

The long-term fertilizers according to the present invention are characterized in that they permit particularly efficient intensive use of areas used for agriculture and horticulture, whereby a burden on the environment is avoided to a great extent.

The long-term fertilizers according to the invention are applied to the areas used for agriculture or horticulture according to usual methods, or mixed into the substrate of pot or container cultures, or sprinkled on.

For optimum promotion of growth of the plants, it is generally sufficient to apply the long-term fertilizers according to the invention to the agricultural surface once per growth period (preferably at its beginning). This is because the progression of the nutrient demand of the plants and the progression of the release of the active fertilizer ingredients agree with one another.

### DETAILED DESCRIPTION OF PREFERRED EMBODIMENTS

The invention will be explained in greater detail below, using examples.

### EXAMPLES

To demonstrate the good and long-lasting effect of the formulations according to the invention, extensive agricultural experiments were conducted. Isobutylidene diurea (IBDH), acetylene diurea (ADH), ethylene diurea (EDH), and triuret were tested as the sole sources of long-term nitrogen, as were mixtures with IBDH in a ratio of 67%/33% (container experiments) and 60%/40% (field experiments). The fertilizers contained the other main and secondary ingredients, as well as some easily soluble nitrogen for an initial effect, in equal amounts.

The container experiments were carried out in Mitscherlich containers with Weidel grass as the test culture, and the grass was mowed at regular intervals, its dry mass was determined, and it was analyzed for its N content. The amount of N absorbed per mowing was calculated by means of both variables, addition results in the nitrogen utilization. The results are shown in Table 1. Table 1 makes it clear that when using IBDH+ADH in combination, the nitrogen utilization of fertilization is clearly higher than if one of the two long-term forms of nitrogen is administered alone. In this connection, the N utilization is 75%, while theoretically, the given shares of the long-term fertilizer components in each instance, result in a utilization of only 59%. The combinations of IBDH with other forms of nitrogen, without ADH, do not demonstrate these advantages.

TABLE 1
Nitrogen utilization by means of different long-term fertilizer
combinations (% nitrogen in leaves of Weidel grass in relation
to the amount of nitrogen applied, in total; Mitscherlich
containers; 5 L soil; 2.4 g/container N; 9 mowings; 23 to 207
days after fertilization)

| | | | N |
|---|---|---|---|
| | | N | utilization |
| | | utilization | %, |
| | | %, | predicted |
| Long-term fertilizer compound | | measured | value |
| proportion | | (real) | (calculated) |
| 100% | IBDH-N | 54 | — |
| 100% | ADH-N | 70 | — |
| 67% + 33% | IBDH + ADH-N | 75 | 59 |
| 100% | EDH-N | 68 | — |
| 67% + 33% | IBDHN + EDH-N | 56 | 58 |
| 100% | Triuret-N | 38 | — |
| 67% + 33% | IBDH N + Triuret-N | 50 | 48 |
| 100% | CDU-N | 58 | — |
| 67% + 33% | IBDH N + CDU-N | 54 | 55 |

In addition to container experiments, the fertilizer combination was also tested in field experiments on lawns, a main area of use of slow-acting nitrogen forms. The assessment criteria in this connection are the color appearance for the optical quality, as well as the growth height as a measure of the regeneration strength of the sod. The fertilizers were applied once, in an application amount of 20 g/m² N. The results are summarized in Tables 2 and 3. The figures in Tables 2 and 3 show that both in terms of the color appearance and in terms of the growth height, values above expectations were achieved with the combination of IBDH and ADH.

Thus, the real assessment marks for color appearance in Table 2, other than at the time of 124 days after fertilization, were clearly above the calculated predicted value. Here again, it was evident that the synergistic effects did not occur with the other combinations of long-term fertilizer forms. A comparable picture is given by Table 3 with regard to the growth heights of the sod (Table 3).

Accordingly, while a few embodiments of the present invention have been shown and described, it is to be understood that many changes and modifications may be made thereunto without departing from the spirit and scope of the invention as defined in the appended claims.

TABLE 2
Appearance of lawns when using different long-term nitrogen fertilizer combinations
(Appearance assessment 1-9, 9 = dark-green dense sod; fertilization on March 21, 2000, with 20 g/m²N;
assessment every two weeks)

| | Days after fertilization | | | | | | | | | | | | |
|---|---|---|---|---|---|---|---|---|---|---|---|---|---|
| | 27 | 40 | 54 | 66 | 81 | 109 | 124 | 139 | 153 | 166 | 173 | 187 | AVG. |
| 100% IBDH-N | 8,10 | 7,90 | 6,80 | 5,40 | 4,50 | 5,00 | 4,90 | 5,30 | 5,30 | 4,50 | 4,30 | 3,80 | 5,48 |
| 100% ADH-N | 6,10 | 7,50 | 8,50 | 8,00 | 8,40 | 7,10 | 6,10 | 5,60 | 5,60 | 5,00 | 4,40 | 3,90 | 6,35 |
| 50% IBDH + 50% | 7,50 | 8,00 | 8,00 | 7,00 | 6,60 | 6,40 | 5,50 | 5,80 | 5,60 | 5,00 | 4,50 | 3,90 | 6,15 |
| ADH-N | | | | | | | | | | | | | |
| Predicted value | 7,10 | 7,70 | 7,65 | 6,70 | 6,45 | 6,05 | 5,50 | 5,45 | 5,45 | 4,75 | 4,35 | 3,85 | 5,92 |
| Deviation as compared | 0,40 | 0,30 | 0,35 | 0,30 | 0,15 | 0,35 | 0,00 | 0,35 | 0,15 | 0,25 | 0,15 | 0,05 | 0,23 |
| with predicted value | | | | | | | | | | | | | |
| 100% IBDH-N | 8,10 | 7,90 | 6,80 | 5,40 | 4,50 | 5,00 | 4,90 | 5,30 | 5,30 | 4,50 | 4,30 | 3,80 | 5,48 |
| 100% EDH-N | 6,90 | 5,80 | 5,80 | 5,30 | 5,60 | 7,40 | 5,80 | 5,90 | 5,80 | 5,00 | 4,60 | 3,90 | 5,65 |
| 50% IBDH + 50% | 7,40 | 6,80 | 6,10 | 5,40 | 5,00 | 6,20 | 5,40 | 5,50 | 5,40 | 4,60 | 4,00 | 3,50 | 5,44 |
| EDH-N | | | | | | | | | | | | | |
| Predicted value | 7,50 | 6,85 | 6,30 | 5,35 | 5,05 | 6,20 | 5,35 | 5,60 | 5,55 | 4,75 | 4,45 | 3,85 | 5,57 |
| Deviation as compared | −0,10 | −0,05 | −0,20 | 0,05 | −0,05 | 0,00 | 0,05 | −0,10 | −0,15 | −0,15 | −0,45 | −0,35 | −0,13 |
| with predicted value | | | | | | | | | | | | | |
| 100% IBDH-N | 8,10 | 7,90 | 6,80 | 5,40 | 5,10 | 5,00 | 5,20 | 5,30 | 5,30 | 4,50 | 4,30 | 3,80 | 5,56 |
| 100% Triuret-N | 6,40 | 6,00 | 7,10 | 6,80 | 6,00 | 6,40 | 5,90 | 6,40 | 6,00 | 5,40 | 4,80 | 4,40 | 5,97 |
| 50% IBDH + 50% | 7,30 | 6,80 | 6,70 | 6,20 | 5,60 | 5,60 | 5,50 | 5,90 | 5,30 | 5,00 | 4,50 | 4,00 | 5,70 |
| Triuret-N | | | | | | | | | | | | | |
| Predicted value | 7,25 | 6,95 | 6,95 | 6,10 | 5,55 | 5,70 | 5,55 | 5,85 | 5,65 | 4,95 | 4,55 | 4,10 | 5,76 |
| Deviation as compared | 0,05 | −0,15 | −0,25 | 0,10 | 0,05 | −0,10 | −0,05 | 0,05 | −0,35 | 0,05 | −0,05 | −0,10 | −0,06 |
| with predicted value | | | | | | | | | | | | | |
| 100% IBDH-N | 8,10 | 7,90 | 6,80 | 5,40 | 4,50 | 5,00 | 4,90 | 5,30 | 5,30 | 4,50 | 4,30 | 3,80 | 5,48 |
| 100% CDU-N | 6,60 | 7,80 | 8,50 | 7,90 | 6,80 | 5,90 | 5,00 | 5,60 | 5,40 | 4,90 | 4,60 | 4,00 | 6,08 |
| 50% IBDH + 50% | 7,40 | 7,90 | 7,50 | 6,60 | 5,10 | 5,30 | 5,00 | 5,50 | 5,30 | 4,60 | 4,30 | 3,90 | 5,70 |
| CDU-N | | | | | | | | | | | | | |
| Predicted value | 7,35 | 7,85 | 7,65 | 6,65 | 5,65 | 5,45 | 4,95 | 5,45 | 5,35 | 4,70 | 4,45 | 3,90 | 5,78 |
| Deviation as compared | 0,05 | 0,05 | −0,15 | −0,05 | −0,55 | −0,15 | 0,05 | 0,05 | −0,05 | −0,10 | −0,15 | 0,00 | −0,08 |
| with predicted value | | | | | | | | | | | | | |

TABLE 3
Growth of lawns when using different long-term nitrogen fertilizer combinations over the course of the vegetation period
(Fertilization on March 21, 2000, with 20 g/m²N; growth height measurement before every mowing in cm above soil surface; 1
mowing/week)

| | Days after fertilization | | | | | | | | | | | | | |
|---|---|---|---|---|---|---|---|---|---|---|---|---|---|---|
| | 21 | 27 | 35 | 43 | 49 | 57 | 64 | 70 | 77 | 86 | 91 | 98 | 106 | 113 |
| 100% IBDH-N | 8,35 | 10,3 | 10,4 | 13,58 | 6,93 | 4,9 | 6,9 | 6,05 | 5,83 | 3,7 | 4,88 | 5,13 | 3,38 | 4,48 |
| 100% ADH-N | 6,35 | 7,38 | 5,5 | 11,1 | 7,1 | 5,63 | 7,55 | 6,18 | 6,75 | 4,73 | 4,85 | 6,48 | 4,93 | 5,68 |
| 50% IBDH + 50% | 7,45 | 8,9 | 8,43 | 12,8 | 7,43 | 5,72 | 7,73 | 6,68 | 6,58 | 4,4 | 5,28 | 5,95 | 4,15 | 5,25 |
| ADH-N | | | | | | | | | | | | | | |
| Predicted value | 7,35 | 8,84 | 7,95 | 12,34 | 7,02 | 5,27 | 7,23 | 6,12 | 6,29 | 4,22 | 4,87 | 5,81 | 4,16 | 5,08 |
| Deviation as compared | 0,10 | 0,05 | 0,45 | 0,46 | 0,42 | 0,45 | 0,51 | 0,57 | 0,29 | 0,19 | 0,42 | 0,15 | 0,00 | 0,17 |
| with predicted value | | | | | | | | | | | | | | |
| 100% IBDH-N | 8,35 | 10,3 | 10,4 | 13,58 | 6,93 | 4,9 | 6,9 | 6,05 | 5,83 | 3,7 | 4,88 | 5,13 | 3,38 | 4,48 |
| 100% EDH-N | 7 | 8,3 | 5,95 | 9 | 5,65 | 4,08 | 6,53 | 6,05 | 5,73 | 4,45 | 6,5 | 6,55 | 4,8 | 6,05 |
| 50% IBDH + 50% | 7,6 | 9,35 | 8,08 | 10,48 | 5,93 | 4,35 | 6,23 | 5,9 | 5,7 | 4,15 | 5,65 | 5,63 | 4,1 | 4,9 |
| EDH-N | | | | | | | | | | | | | | |
| Predicted value | 7.68 | 9,30 | 8,18 | 11,29 | 6,29 | 4,49 | 6,72 | 6,05 | 5,78 | 4,08 | 5,69 | 5,84 | 4,09 | 5,27 |
| Deviation as compared | −0,08 | 0,05 | −0,10 | −0,81 | −0,36 | −0,14 | −0,48 | −0,15 | −0,08 | 0,08 | −0,04 | −0,21 | 0,01 | −0,37 |
| th predicted value | | | | | | | | | | | | | | |
| 100% IBDH-N | 8,35 | 10,3 | 10,4 | 13,58 | 6,93 | 4,9 | 6,9 | 6,05 | 5,83 | 3,7 | 4,88 | 5,13 | 3,38 | 4,48 |
| 100% Triuret-N | 6,83 | 7,93 | 6,3 | 9,43 | 5,85 | 4,33 | 6,95 | 6,13 | 6,05 | 4,18 | 5,38 | 5,6 | 4,13 | 5,35 |
| 50% IBDH + 50% | 7,48 | 9,13 | 8,63 | 11,83 | 6,55 | 4,75 | 6,83 | 6,25 | 6,08 | 4,13 | 5,08 | 5,4 | 3,98 | 5,13 |
| Triuret-N | | | | | | | | | | | | | | |
| Predicted value | 7,59 | 9,12 | 8,35 | 11,51 | 6,39 | 4,62 | 6,93 | 6,09 | 5,94 | 3,94 | 5,13 | 5,37 | 3,76 | 4,92 |
| Deviation as compared | 0,11 | 0,02 | 0,28 | 0,33 | 0,16 | 0,14 | −0,10 | 0,16 | 0,14 | 0,19 | −0,05 | 0,04 | 0,23 | 0,22 |
| with predicted value | | | | | | | | | | | | | | |
| 100% IBDH-N | 8,35 | 10,3 | 10,4 | 12,58 | 6,93 | 4,9 | 6,9 | 6,05 | 5,83 | 3,7 | 4,88 | 5,13 | 3,38 | 4,48 |
| 100% CDU-N | 6,93 | 8,08 | 6,9 | 12 | 7,3 | 5,93 | 8,43 | 7,03 | 6,98 | 4,58 | 5,43 | 5,35 | 3,85 | 4,95 |
| 50% IBDH + 50% | 7,38 | 8,9 | 8,7 | 12,08 | 7,2 | 5,13 | 7,53 | 6,55 | 6,08 | 4 | 5,08 | 5,15 | 3,5 | 4,75 |
| CDU-N | | | | | | | | | | | | | | |
| Predicted value | 7,64 | 9,19 | 8,65 | 1,29 | 7,12 | 5,42 | 7,67 | 6,64 | 6,41 | 4,14 | 5,16 | 5,24 | 3,62 | 4,72 |
| Deviation as compared | −0,26 | −0,29 | 0,05 | −0,21 | 0,09 | −0,29 | −0,14 | 0,01 | −0,33 | −0,14 | −0,07 | −0,09 | −0,12 | 0,04 |
| with predicted value | | | | | | | | | | | | | | |

| | Days after fertilization | | | | | | | | | | | | |
|---|---|---|---|---|---|---|---|---|---|---|---|---|---|
| | 120 | 127 | 134 | 141 | 147 | 155 | 161 | 169 | 176 | 183 | 190 | 196 | AVG. |
| 100% IBDH-N | 4,93 | 4,4 | 4,68 | 4,88 | 4,15 | 4,93 | 4,53 | 4,18 | 4,13 | 3,68 | 4,25 | 4,18 | 5,68 |
| 100% ADH-N | 6,08 | 5,3 | 5,35 | 5,7 | 4,58 | 5,38 | 4,85 | 4,43 | 4,33 | 4,13 | 4,65 | 4,33 | 5,74 |
| 50% IBDH + 50% | 5,63 | 5,13 | 5,13 | 5,4 | 4,6 | 5,35 | 4,98 | 4,38 | 4,23 | 3,98 | 4,33 | 4,25 | 5,93 |
| ADH-N | | | | | | | | | | | | | |
| Predicted value | 5,51 | 4,85 | 5,02 | 5,29 | 4,37 | 5,16 | 4,69 | 4,31 | 4,23 | 3,91 | 4,45 | 4,26 | 5,71 |
| Deviation as compared | 0,13 | 0,28 | 0,12 | 0,11 | 0,23 | 0,20 | 0,29 | 0,08 | 0,00 | 0,07 | −1,12 | 0,00 | 0,22 |
| with predicted value | | | | | | | | | | | | | |
| 100% IBDH-N | 4,93 | 4,4 | 4,68 | 4,88 | 4,15 | 4,93 | 4,53 | 4,18 | 4,13 | 3,68 | 4,25 | 4,18 | 5,68 |
| 100% EDH-N | 6,23 | 5,35 | 5,6 | 5,53 | 4,43 | 5,48 | 4,98 | 4,38 | 4,38 | 4,05 | 4,28 | 4,33 | 5,60 |
| 50% IBDH + 50% | 5,35 | 4,8 | 5 | 5,3 | 4,4 | 5,03 | 4,7 | 4,3 | 4,2 | 3,95 | 4,28 | 4,23 | 5,52 |
| EDH-N | | | | | | | | | | | | | |
| Predicted value | 5,58 | 4,88 | 5,14 | 5,21 | 4,76 | 4,28 | 4,26 | 3,87 | 4,27 | 4,26 | 5,64 | | |
| Deviation as compared | −0,23 | −0,08 | −0,14 | 0,09 | 0,11 | −0,18 | −0,06 | 0,02 | −0,05 | 0,09 | 0,01 | −0,02 | −0,12 |
| with predicted value | | | | | | | | | | | | | |
| 100% IBDH-N | 4,93 | 4,4 | 4,68 | 4,88 | 4,15 | 4,93 | 4,53 | 4,18 | 4,13 | 3,68 | 4,25 | 4,18 | 5,68 |
| 100% Triuret-N | 5,75 | 5,23 | 5,45 | 5,75 | 4,7 | 5,73 | 4,98 | 4,4 | 4,3 | 4,2 | 4,55 | 4,33 | 5,53 |
| 50% IBDH + 50% | 5,53 | 5,05 | 5,08 | 5,45 | 4,68 | 5,13 | 4,7 | 4,3 | 4,15 | 4 | 4,3 | 4,28 | 5,69 |
| Triuret-N | | | | | | | | | | | | | |
| Predicted value | 5,34 | 4,82 | 5,07 | 5,32 | 4,43 | 5,33 | 4,76 | 4,29 | 4,22 | 3,94 | 4,40 | 4,26 | 5,61 |
| Deviation as compared | 0,19 | 0,23 | 0,02 | 0,14 | 0,25 | −0,20 | −0,06 | 0,01 | −0,06 | 0,06 | −0,10 | 0,03 | 0,08 |
| with predicted value | | | | | | | | | | | | | |
| 100% IBDH-N | 4,93 | 4,4 | 4,68 | 4,88 | 4,15 | 4,93 | 4,53 | 4,18 | 4,13 | 3,68 | 4,25 | 4,18 | 5,64 |
| 100% CDU-N | 5,33 | 4,63 | 5,05 | 5,28 | 4,4 | 4,98 | 4,68 | 4,15 | 4,15 | 3,9 | 4,33 | 4,2 | 5,72 |
| 50% IBDH + 50% | 5,3 | 4,58 | 4,98 | 5,13 | 4,5 | 4,93 | 4,55 | 4,13 | 4,13 | 3,78 | 4,28 | 4,15 | 5,63 |
| CDU-N | | | | | | | | | | | | | |
| Predicted value | 5,13 | 4,52 | 4,87 | 5,08 | 4,28 | 4,61 | 4,17 | 4,14 | 3,79 | 4,29 | 4,19 | 5,68 | |
| Deviation as compared | 0,17 | 0,06 | 0,12 | 0,05 | 0,23 | −0,03 | −0,06 | −0,04 | −0,01 | −0,01 | −0,01 | −0,04 | −0,05 |
| with predicted value | | | | | | | | | | | | | |

What is claimed is:

1. Long-term fertilizer containing nitrogen, comprising
a mixture of acetylene diurea and at least one other organic fertilizer containing nitrogen.

2. Long-term fertilizer according to claim 1,
wherein the at least one other organic fertilizer containing nitrogen is selected from the group consisting of methylene urea, isobutylidene diurea, crotonylidene diurea, oxamide, melamine, substituted triazones, ethylene diurea, triuret, and mixtures thereof.

3. Long-term fertilizer according to claim 2,
wherein that the at least one other organic fertilizer containing nitrogen is isobutylidene diurea.

4. Long-term fertilizer according to claim 1,
wherein acetylene diurea and the at least one other organic fertilizer containing nitrogen are present in a weight ratio of 1:9 to 9:1.

5. Long-term fertilizer according to claim 1, further comprising
a substance selected from the group consisting of urea, nitrogen, potassium, phosphorus, magnesium, in the form of an inorganic salt of each substance, or a mixture of inorganic salts thereof.

6. Long-term fertilizer according to claim 1, further comprising
a secondary nutrient, selected from the group consisting of Ca, S, B, trace elements, selected from the group consisting of Fe, Mn, Cu, Zn, Mo and mixtures thereof, in the form of inorganic salts, plant protection agents, growth regulators, nitrification inhibitors, or mixtures thereof.

7. A process for the production of long-term fertilizers, comprising
mixing powders or granules of starting compounds comprising a mixture of acetylene diurea and at least one other organic fertilizer containing nitrogen; and
if necessary, subsequent granulation.

8. In a method for fertilizing horticultural or agricultural cultures, the improvement which comprises
utilizing the long term fertilizer of claim 1 for said fertilizing.
